(19) United States
(12) Patent Application Publication
(10) Pub. No.: US 2024/0296084 A1
(43) Pub. Date: Sep. 5, 2024

(54) SYSTEMS AND METHODS FOR MEASURING SYSTEM PERFORMANCES

(71) Applicant: SAUDI ARABIAN OIL COMPANY, Dhahran (SA)

(72) Inventors: Mohammad J. AL MUMEN, Dhahran (SA); Alaa M. ZARBAN, Dhahran (SA)

(73) Assignee: SAUDI ARABIAN OIL COMPANY, Dhahran (SA)

(21) Appl. No.: 18/177,508

(22) Filed: Mar. 2, 2023

(51) Int. Cl. G06F 9/54; G06F 11/34

(52) U.S. Cl. CPC G06F 9/547; G06F 11/3409

(57) ABSTRACT

In some examples, a system includes a remote call library configured to enable communications with a monitored system, a repository configured to store one or more relationships between a plurality of components of the monitored system, and a performance measurement module, implemented by at least one processor, configured to measure a performance of the monitored system using one or more remote calls of the remote call library based on at least one relationship of the one or more relationships between the plurality of components. In some examples, a method for measuring the performance of the monitored system can include identifying a number of monitored systems or system components, determining one or more relationships of the monitored systems or system components, determining the performance of the monitored systems or of the system components based on the one or more relationships, and generating a report of the performance.

### FIELD OF THE DISCLOSURE

The present disclosure relates generally to monitoring system performance, and more particularly, to systems and methods for digitally measuring performance of components of the system.

### BACKGROUND OF THE DISCLOSURE

The term “enterprise resources,” as used herein, can refer to one or more of systems, computer applications, or data of an organization. The enterprise resources may include multiple systems, multiple computer applications, multiple data sets, or a combination thereof. A system may include multiple components, each of which provides a different function. Standard components, such as those for dispatching, work processing, queueing, load balancing, or the like, may perform common functions that govern operations of the system or may be data related to operations of the system, such as databases. Middleware components, such as those that perform virus scanning, document processing, archiving, or the like, can use one or more of the standard components to provide services to one or more computer applications of the system. Computer applications, such as a workflow engine, or the like, use one or more of the middleware components to perform a specified task. An organization may use an enterprise resource planning (ERP) system to manage the multiple systems, computer applications, and data sets. The ERP system may be an SAP® system, for instance. Due to a number of components and a complexity of interaction between the components, performance measurements of the system typically provide aggregated data of multiple components, impeding an ability to analyze the system at a component level. The aggregated data may be an average performance based on aggregated effects from performances of multiple components, for instance. Additionally, performance measurements of the system may exclude data of one or more middleware or computer application components.

### SUMMARY OF THE DISCLOSURE

Various details of the present disclosure are hereinafter summarized to provide a basic understanding. This summary is not an extensive overview of the disclosure and is neither intended to identify certain elements of the disclosure, nor to delineate the scope thereof. Rather, the primary purpose of this summary is to present some concepts of the disclosure in a simplified form prior to the more detailed description that is presented hereinafter.

According to an embodiment consistent with the present disclosure, a system can include a remote call library configured to enable communications with a monitored system, a repository configured to store one or more relationships between a plurality of components of the monitored system, and a performance measurement module, implemented by at least one processor, configured to measure a performance of the monitored system using one or more remote calls of the remote call library based on at least one relationship of the one or more relationships between the plurality of components.

According to another embodiment consistent with the present disclosure, a method can include identifying a number of monitored systems or system components, determining one or more relationships of the monitored systems or system components, determining a performance of the monitored systems or of the system components based on the one or more relationships, and generating a report of the performance.

In another embodiment consistent with the present disclosure, a computer-readable medium storing machine-readable instructions, which, when executed by a processor, cause the processor to identify a monitored system or system components, determine at least one relationship between a plurality of components of the monitored system or system components, measure a performance of the monitored system or system components using one or more remote calls of a remote call library based on the at least one relationship, and transmit the performance via an application programming interface (API).

Any combinations of the various embodiments and implementations disclosed herein can be used in a further embodiment, consistent with the disclosure. These and other aspects and features are better appreciated according to the following description of certain embodiments presented herein in accordance with the disclosure and the accompanying drawings and claims.

### BRIEF DESCRIPTION OF THE DRAWINGS

FIG. 1 is a system for monitoring system performances, in accordance with certain embodiments.

FIG. 2 is a flowchart of a method for measuring system performances, in accordance with certain embodiments.

FIG. 3 is a flowchart of a method for measuring system performances, in accordance with certain embodiments.

FIG. 4 is a flowchart of a method for maintaining a system for measuring system performances, in accordance with certain embodiments.

FIG. 5 is an example output of a system or method for measuring system performances, in accordance with certain embodiments.

FIG. 6 is a block diagram of a computer system that can be employed to monitor or measure system performances, in accordance with certain embodiments.

### DETAILED DESCRIPTION

Embodiments of the present disclosure will now be described in detail with reference to the accompanying Figures. Further, in the following detailed description of embodiments of the present disclosure, numerous specific details are set forth in order to provide a more thorough understanding of the claimed subject matter. However, it will be apparent to one of ordinary skill in the art that the embodiments disclosed herein may be practiced without these specific details. In other instances, well-known features have not been described in detail to avoid unnecessarily complicating the description. Additionally, it will be apparent to one of ordinary skill in the art that the scale of the elements presented in the accompanying Figures may vary without departing from the scope of the present disclosure.

Embodiments in accordance with the present disclosure generally relate to monitoring a system performance, and more particularly, to systems and methods for digitally monitoring performance of components of the system. The system being monitored is herein referred to as a monitored system. The monitored system may be an SAP system, for example. According to various embodiments, a monitoring system communicates with a component performance measurement system via an application programming interface (API) module of the component performance measurement system. The component performance measurement system may include a probing mechanism of components of the monitored system that includes a repository storing relationships between one or more components within a monitored system. As described above, the one or more components may include standard components, middleware components, computer application components, or a combination thereof. A component may be implemented using software, hardware, or a combination thereof. Because the repository associated with monitoring the monitored system stores relationships of the one or more components of the monitored system, a modification to the one or more components of the monitored system does not necessarily equate to a modification of the repository. Additionally, relationships between the one or more components stored to the repository may be modified without necessarily equating to a modification of one or more of the one or more components of the monitored system.

In a non-limiting example, in response to a communication from the monitoring system, a performance measurement module of the component performance measurement system retrieves relevant data from the repository of the component performance measurement system. The relevant data may be based on the communication enabling a user selection of an option provided by a maintenance module of the component performance measurement system, for example. The maintenance module may enable a user of the monitoring system to select a maintenance function, such as adding, removing, updating, or the like, a monitored system or components thereof. Based on the data, the component performance measurement system communicates with the monitored system using a remote call library indicated by the data. The remote call library, as used herein, is an interface module that enables the component performance measurement system to access one or more internal functions, procedures, or the like, of the monitored system associated with the remote call library. Based on the remote call, a component performance function module of the monitored system determines one or more measurements of one or more components of the monitored system and transmits the one or more measurements to the component measurement function module. In a non-limiting example, the one or more measurements may include a timing, such as a time period of use of the one or more components. The one or more components of the monitored system may include one or more standard components, one or more middleware components, one or more computer applications, one or more databases, or a combination thereof. A computer application, as used herein, may include any type of software, program, or automated process having computer-executable instructions, which, when executed, enable access to specified operations or data of one or more systems. Non-limiting examples of a computer application include a word processing application, a spreadsheet application, a presentation application, a videoconferencing application, or the like. The API module converts the one or more measurements to a specified format for the monitoring system and transmits the converted measurements to the monitoring system, in a non-limiting example.

As described above, challenges to measuring performance of an organization's enterprise resources may include the enterprise resources including a number of monitored systems, a number of components of a monitored system, a complexity of interaction between the components of the monitored system, a complexity of interaction between multiple monitored systems, or a combination thereof. Performance measurements of the enterprise resources aggregating data of multiple monitored systems, multiple components of one or more of the multiple monitored systems, or a combination thereof, impede an ability to analyze one or more of the multiple monitored systems at a component level. Additionally, measurement components of one or more of the multiple monitored systems may exclude modules that enable performance measurements of one or more middleware or computer application components.

Embodiments described herein enable monitoring of standard, middleware, and computer application components of one or more monitored systems by providing a probing mechanism of the different components of the monitored system and including a repository storing relationships of the different components within the monitored system. Monitoring the performance of components of the one or more monitored systems provides diagnostic information that enables determination of root cause of problems with the one or more monitored systems. The problems may be indicated by a response time, a processor usage, a memory usage, or the like, that for example increases over time, exceeds a specified threshold, the like, or by other indications of anomalies in component performance, a specific subset of components performance, or a monitored system performance. The problems may lead to a decrease in availability of one or more services provided by the monitored system, which decreases user productivity, and causes user dissatisfaction with the monitored system. The monitoring enables collection of data on each component of each monitored system over time. The collection of data provides information for establishing baseline performance indicators of each component, of each monitored system, and of each set of relationships between multiple components. Establishment of baseline performance may enhance optimization of monitored system performance by enabling improved scheduling of component usage. The improved scheduling of component usage may result in decreased noise during another component's use, for example. The monitoring may provide indications that a specific component or specific subset of components of the monitored system are responsible for a decrease in the monitored system responsiveness, for example. The monitoring enables identification of anomalies that may lead to cascading performance issues. Identifying root causes, to include prior to a cascading failure, may prevent or reduce monitored system downtime, thereby increasing monitored system stability and user productivity and improving user satisfaction.

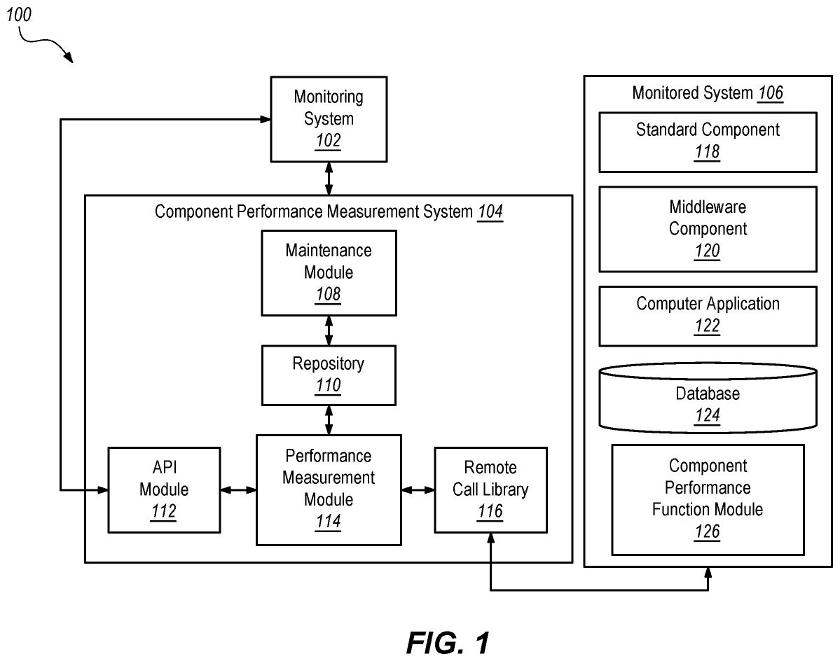

FIG. 1 is a system 100 for monitoring system performances, in accordance with certain embodiments. The system 100 includes a monitoring system 102 for managing enterprise resources, such as the monitored system 106, and that uses a component performance management (CPM) system 104 for measuring performance of the enterprise resources. In a non-limiting example, the monitoring system 102 transmits data to the CPM system 104. The data may include one or more identifiers, or the like, of monitored systems (e.g., the monitored system 106) for which the monitoring system 102 is requesting performance data. The monitored systems include one or more SAP systems, in a non-limiting example. The CPM system 104 uses the data to determine one or more relationships between components of each monitored system indicated by the one or more identifiers. As described above, the one or more components may include standard components, middleware components, computer application components, or a combination thereof, and the one or more relationships indicate dependencies between the different components. For example, a middleware component may utilize multiple standard components, and multiple computer application components may, in turn, utilize the middleware component. The one or more relationships may include an indication that the middleware component uses each of the multiple standard components, that each computer application component of the multiple computer application components uses the middleware component, that each computer application of the multiple computer application components uses each of the multiple standard components used by the middleware component, or a combination thereof. Based on the one or more relationships, the CPM system 104 uses one or more remote calls available via the remote call library 116 to request one or more measurements from the monitored system 106. In a non-limiting example, the remote call library 116 includes multiple remote call libraries. Each remote call library of the multiple remote call libraries may be associated with a different monitored system of multiple monitored systems, a subset of components of the monitored system 106, or a combination thereof, for example. The CPM system 104 converts the one or more measurements to the requested performance data. In a non-limiting example, the CPM system 104 compares the one or more measurements to one or more thresholds to covert the one or more measurements to the requested performance data. In another non-limiting example, the CPM system 104 converts a format of the one or more measurements to a format specified by the monitoring system 102 to convert the one or more measurements to the requested performance data. The CPM system 104 transmits the requested performance data to the monitoring system 102.

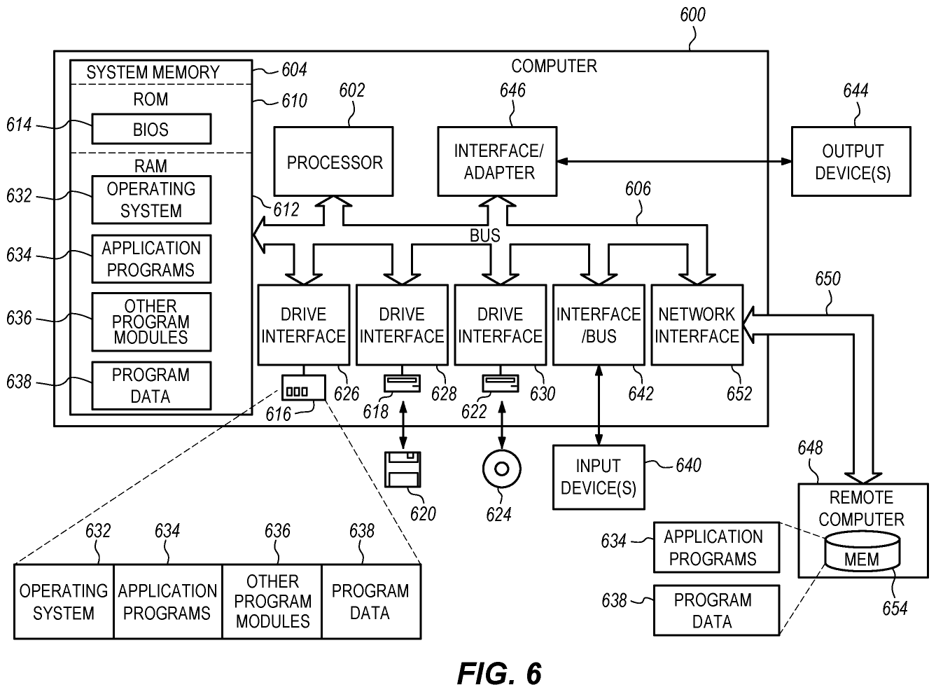

In a non-limiting example, the monitoring system 102 includes modules implemented in software, hardware, or a combination thereof, and operable to manage enterprise resources. The monitoring system 102 may be implemented, in whole or in part, as a computer system 600 of FIG. 6, for example. The monitoring system 102 may include one or more input devices, one or more display devices displaying one or more graphical user interfaces (GUIs), or a combination thereof, that enables a user (e.g., technician, systems administrator, owner, operator) to select one or more monitored systems for which to maintain or receive performance information. In a non-limiting example, the GUI is displayed via a browser of a computer application installed to the monitoring system 102. In another non-limiting example, the CPM system 104 includes a web-based interface or application programming interface (API) module 112 accessible by a browser of the monitoring system 102.

In a non-limiting example, the monitoring system 102 transmits data including the selection to the CPM system 104. The data may include an indicator of an action to perform (e.g., maintain, measure), an identifier for each of the one or more monitored systems selected, or a combination thereof. The CPM system 104 may be implemented, in whole or in part, by the computer system 600 of FIG. 6, for example. As described herein with respect to FIG. 6, one or more of the maintenance module 108, the repository 110, the API module 112, the performance measurement module 114, and the remote call library 116 may be a software module, a hardware module, or a combination thereof, and may include computer-readable media for storage of data, machine-readable instructions, or a combination thereof, as well as other hardware (e.g., a processor, input devices, output devices) for performing operations associated with the corresponding module. By way of example, the computer-readable media can be implemented as a non-transitory computer storage medium, such as volatile memory (e.g., random access memory (RAM), such as DRAM), non-volatile memory (e.g., a hard disk drive, a solid-state drive, a flash memory, or the like), or a combination thereof. A processor may be implemented, for example, as a processor core. The computer-readable media can store machine-readable instructions (e.g., computer-executable instructions) that can be retrieved and executed by the processor to perform the operations associated with the corresponding module.

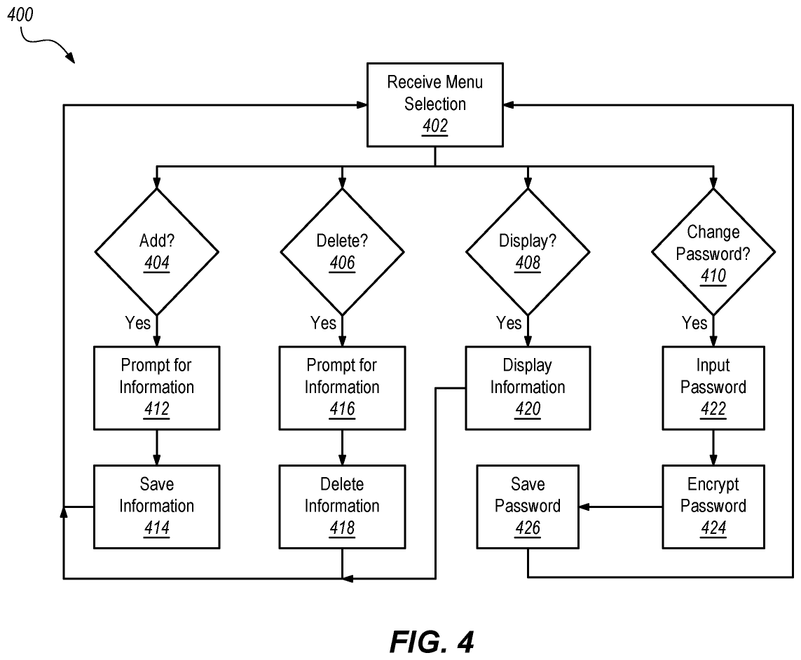

In a non-limiting example, the CPM system 104 receives the data from the monitoring system 102 via the API module 112. In response to a determination by the API module 112 that the indicator of the action to perform received from the monitoring system 102 indicates a maintenance action, the maintenance module 108 performs the maintenance action by updating data stored to the repository 110. As described above, the maintenance module 108 may enable adding, removing, updating, or the like, a monitored system or components thereof. The maintenance module 108 may use the method 400 of FIG. 4 to perform the maintenance action, in a non-limiting example. As described above, the repository 110 stores relationships between the one or more components of systems measurable by the CPM system 104. While in embodiments described herein, the repository 110 is local volatile and/or non-volatile memory of the CPM system 104, in other embodiments not shown, the repository 110 may be on an external server, or may additionally be any computer-readable medium accessible by the CPM system 104.

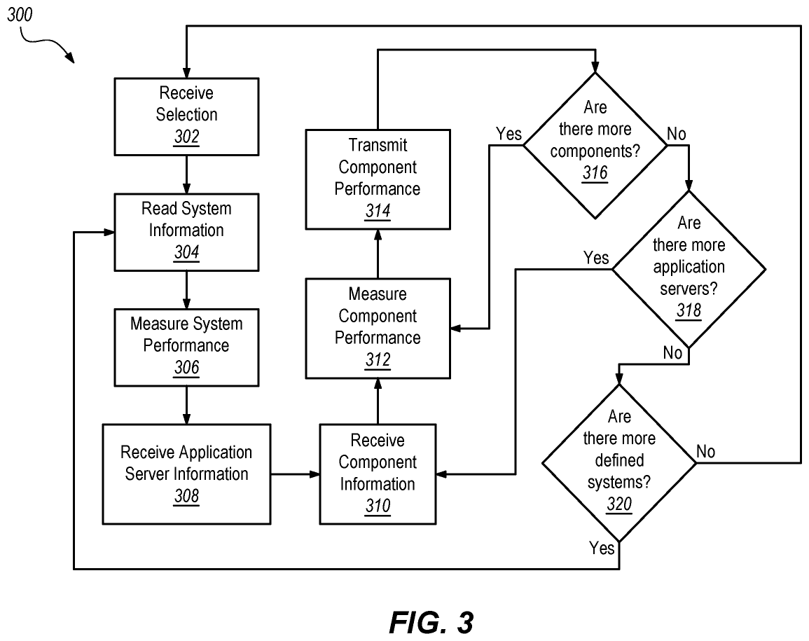

In another non-limiting example, the API module 112 determines that the indicator of the action to perform received from the monitoring system 102 indicates to perform measurements, the performance measurement module 114 identifies each of the monitored systems to be measured using the data received from the monitoring system 102. The performance measurement module 114 retrieves from the repository 110 one or more relationships for each monitored system identified. Based on the one or more relationships for each monitored system, the performance measurement module 114 communicates with each monitored system using one or more specified remote calls available via the remote call library 116. In a non-limiting example, each component is associated with a remote call of the one or more specified remote calls. In another non-limiting example, a first subset of components of the monitored system 106 is associated with a first remote call and a second subset of components of the monitored system 106 is associated with a second remote call. The remote call library 116 is configured to enable communications with monitored system 106. In a non-limiting example, the performance measurement module 114 determines that the data received from the monitoring system 102 indicates to perform measurements on the monitored system 106. The performance measurement module 114 retrieves from the repository 110 one or more relationships of components of the monitored system 106. The performance measurement module 114 measures the performance of the monitored system 106 using specified remote calls that instruct a component performance function (CPF) module 126 of the monitored system 106 to collect one or more measurements, for example. The performance measurement module 114 may use a method 300 of FIG. 3 to perform measurements of the monitored system 106, in a non-limiting example.

The monitored system 106 includes modules implemented in software, hardware, or a combination thereof, and operable for example as one or more of a standard component 118, a middleware component 120, a computer application component 122, a database 124, the CPF module 126, or the like. The monitored system 106 may be implemented, in whole or in part, by a computer system 600 of FIG. 6, for example. As described above, the standard component 118 may be a module for performing a common function that governs operations of the monitored system 106 (e.g., dispatching, work processing, queueing, load balancing, or the like) or may be data related to operations of the monitored system 106. The middleware component 120 uses one or more of the standard components to provide services to one or more computer applications of the system, such as virus scanning, document processing, archiving, or the like, for example. The computer application component 122 uses one or more of middleware components to perform a specified task, such as a workflow engine, a word processing application, a spreadsheet application, a presentation application, a videoconferencing application, or the like, for example. The database 124 is a standard component. In a non-limiting example, the CPF module 126 receives a specified instruction from the CPM system 104. Based on the specified instruction, the CPF module 126 determines one or more measurements associated with one or more of the standard component 118, the middleware component 120, the computer application component 122, or the database 124. The CPF module 126 transmits the one or more measurements to the CPM system 104.

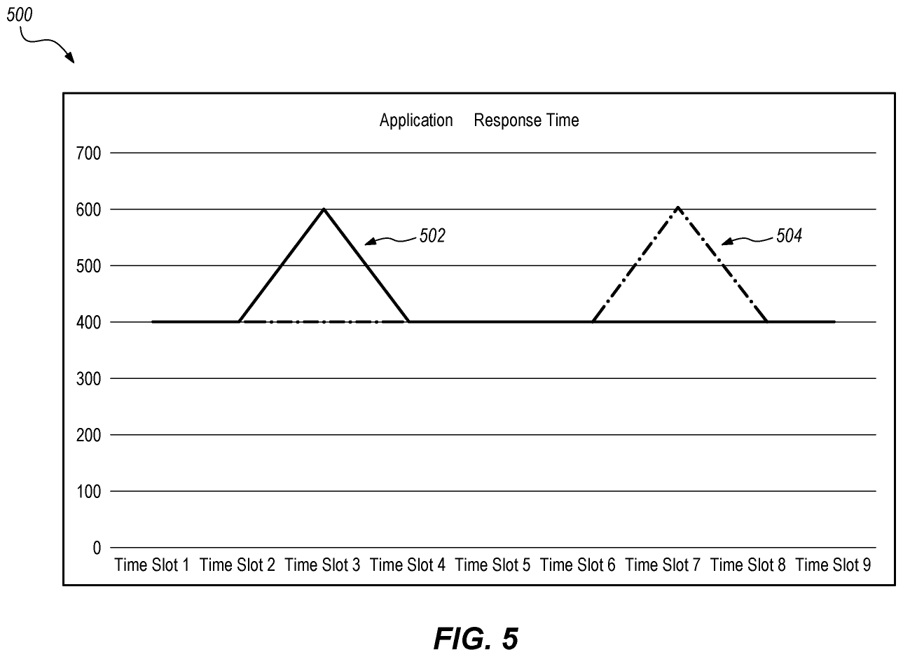

In a non-limiting example, the performance measurement module 114 generates an output graph of the one or more measurements. The output graph may be an example output 500 of FIG. 5. In another non-limiting example, the API module 112 converts the one or more measurements to a specified format for the monitoring system 102 and transmits the converted one or measurements to the monitoring system 102.

In a non-limiting example, the API module 112 is configured to enable communications with a plurality of monitoring systems. The repository 110 is configured to store one or more relationships between a plurality of components of a plurality of monitored systems, between the plurality of monitored systems, or a combination thereof. The performance measurement module 114 is configured to measure performances of the plurality of monitored systems using one or more remote calls of the remote call library 116 based on at least one relationship of the one or more relationships between the plurality of components, the plurality of monitored systems, or the combination thereof. The maintenance module 108 is configured to perform at least one maintenance function based on a communication received via the API module 112. The at least one maintenance function can include one or more of adding data to the repository 110, deleting data from the repository 110, or determining data stored to the repository 110. In a non-limiting example, the plurality of monitored systems includes a first monitored system including a first plurality of components, and a second monitored system including a second plurality of components, and the data includes one or more of a first component of the first plurality of components, the first plurality of components, the first monitored system, the second monitored system, a second component of the second plurality of components, or the second plurality of components.

In another non-limiting example, data stored to the repository 110 is encrypted. For example, the repository 110 is configured to encrypt and decrypt the data received from and transmitted to the maintenance module 108, the performance measurement module 114, or a combination thereof, for storing. In another example, the maintenance module 108 is configured to encrypt and decrypt the one or more relationships between the standard component 118, the middleware component 120, the computer application component 122, and the database 124 of the monitored system 106 as maintenance actions are performed, and the performance measurement module 114 is configured to encrypt the one or more measurements received from the monitored system 106 prior to storing on the repository 110 and to decrypt data retrieved from the repository 110.

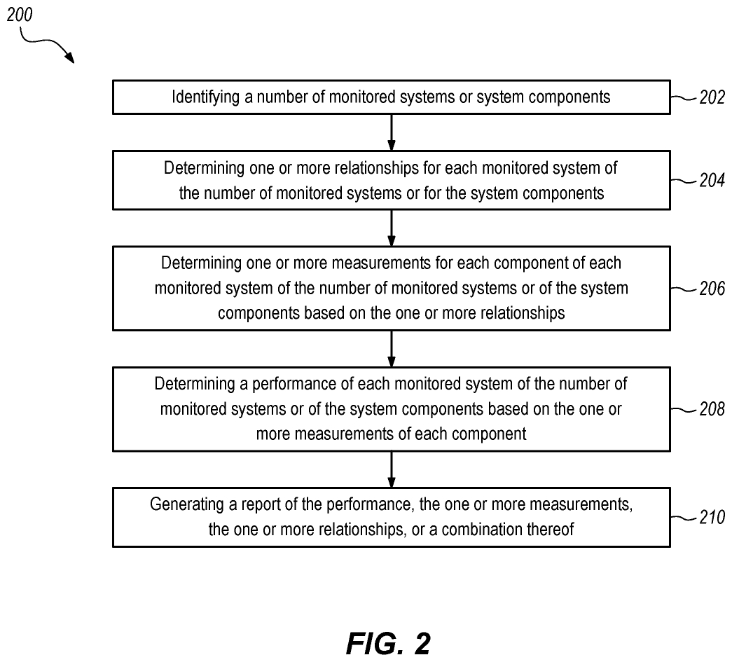

In view of the foregoing structural and functional features described above, example methods will be better appreciated with reference to FIGS. 2-4. While, for purposes of simplicity of explanation, the example methods of FIGS. 2-4 are shown and described as executing serially, it is to be understood and appreciated that the present examples are not limited by the illustrated order, as some actions could in other examples occur in different orders, multiple times and/or concurrently from that shown and described herein. Moreover, it is not necessary that all described actions be performed to implement the methods.

FIG. 2 is a flowchart of a method 200 for measuring system performance, in accordance with certain embodiments. The method 200 can be at least partially implemented by a system, such as the CPM system 104 shown in FIG. 1 and/or the computer system shown in FIG. 6, and may allow data associated with a monitored system (e.g., the monitored system 106 of FIG. 1) to be translated into a graphical output (e.g., the example output 500 of FIG. 5) that identifies and quantifies performance of different components (e.g., the standard component 118, the middleware component 120, the computer application component 122, the database 124) of the monitored system. The method 200 includes identifying a number of monitored systems or system components (202), determining one or more relationships for each monitored system of the number of monitored systems or for the system components (204), determining one or more measurements for one or more components of each monitored system or of the system components based on the one or more relationships (206), determining a performance of each monitored system or of the system components based on the one or more measurements of for one or more components of each monitored system or of the system components (208), and generating a report of the performance, the one or more measurements, the one or more relationships, or a combination thereof (210).

The method 200 may start in response to receiving an input from a user, the present system, another system, or a combination thereof, that indicates the present system is to perform the method 200. In a non-limiting example, the method 200 includes starting in response to receiving data from a monitoring system (e.g., the monitoring system 102). The method 200 includes determining an identifier included in the data, where the data includes an identifier for each of the number of monitored systems or system components selected by a monitoring system. The number of monitored systems or system components may be one or more, for example. The method 200 also includes retrieving one or more relationships stored to a repository (e.g., the repository 110) based on the identifier. In a non-limiting example, the one or more relationships describe a first set of dependencies between a middleware component (e.g., the middleware component 120) and one or more standard components (e.g., the standard component 118, the database 124), a second set of dependencies between a computer application component (e.g., the computer application component 122) and one or more middleware components (e.g., the middleware component 120), a third set of dependencies between the computer application component (e.g., the computer application component 122) and one or more standard components (e.g., the standard component 118, the database 124), or a combination thereof. Additionally, the method 200 includes retrieving one or more measurements of one or more components of each monitored system or of the system components using specified remote calls of a remote call library (e.g., the remote call library 116), where the specified remote calls are determined using the one or more relationships. In some examples, the method 200 can generate an output (e.g., the example output 500 of FIG. 5) characterizing the performance of the monitored system or system components. The output can then be rendered on a display device (e.g., a display device as described with respect to FIG. 6), and thus enable visualization of a result of the method 200. In some examples, the output can be stored in a computer-readable medium (e.g., a computer-readable medium as described with respect to FIG. 1 or 6). The computer-readable medium may be a computer-readable medium of the cloud, which enables remote access, for example.

The method 200 includes storing the one or more measurements of each component of each monitored system of the number of monitored systems or of the system components, in a non-limiting example. Additionally the method 200 includes storing the performance of each monitored system of the number of monitored systems or of the system components. In another non-limiting example, the method 200 includes encrypting the one or more measurements of each component of each monitored system of the number of monitored systems or of the system components and the performance of each monitored system of the number of monitored systems or of the system components prior to storing.

In a non-limiting example, the method 200 includes determining one or more baselines based on the stored one or more measurements of each component of each monitored system of the system components, the stored performance of each monitored system or of the system components, or a combination thereof. The one or more baselines may include at least one of a first baseline of a first monitored system of the number of monitored systems, a second baseline of a computer application component of the first monitored system, or a third baseline of a middleware component of the first monitored system, for example. In a non-limiting example, the method 200 also includes storing the one or more baselines to the repository.

FIG. 3 is a flowchart of a method 300 for measuring system performances, in accordance with certain embodiments. The method 300 can be at least partially implemented by a system, such as the CPM system 104 shown in FIG. 1 and/or the computer system shown in FIG. 6, and may allow data associated with a monitored system (e.g., the monitored system 106 of FIG. 1) to be translated into a graphical output (e.g., the example output 500 of FIG. 5) that identifies and quantifies performance of different components (e.g., the standard component 118, the middleware component 120, the computer application component 122, the database 124) of the monitored system. The method 300 includes receiving a selection (302), reading system information (304), measuring system performance (306), receiving application server information (308), receiving component information (310), measuring component performance (312), transmitting the component performance (314), determining whether there are more components associated with the application server (316), determining whether there are more application servers associated with the system (318), and determining whether there are more systems (320).

The method 300 may start in response to receiving an input from a user, the present system, another system, or a combination thereof, that indicates the present system is to perform the method 300. In a non-limiting example, the method 300 includes starting in response to receiving data from a monitoring system (e.g., the monitoring system 102). The method 300 includes determining one or more identifiers included in the data, the one or more identifiers each identify a different monitored system selected by the monitoring system. In a non-limiting example, the method 300 includes retrieving system information from a repository (e.g., the repository 110) for a first identifier of the one or more identifiers. The method 300 also includes measuring a performance of the system indicated by the first identifier. In a non-limiting example, the method 300 includes using a first remote call of a remote call library (e.g., the remote call library 116) to retrieve the performance of the system. In another non-limiting example, the method 300 includes using multiple remote calls of the remote call library to retrieve multiple measurements associated with one or more components of the system in accordance with a specified sequence. The method 300 also includes comparing at least two of the multiple measurements to determine the performance of the system. For example, the method 300 includes subtracting a first measurement of the multiple measurements from a second measurement of the multiple measurements to determine the performance of a component of the system, a subset of components of the system, the system, or a combination thereof.

Additionally, in a non-limiting example, the method 300 includes retrieving application server information, component information, or a combination thereof, associated with the system from a repository (e.g., receiving application server information (308)). The application server information and the component information may be received as one or more relationships. For example, a first application server information may include a list of components, each having component information, associated with the first application server. In another example, a system indicated by the first identifier may be associated with a list of application servers and each application server may include a list of components.

In a non-limiting example, the method 300 includes using one or more remote calls of the remote call library to retrieve one or more measurements of a first component indicated by the list of components. The method 300 also includes transmitting the one or more measurements for the first component to the monitoring system. In a non-limiting example, the method 300 includes storing the one or more measurements for the first component to the repository. Additionally, the method 300 includes repeating the measurements for each component of the list of components associated with the first application server. In a non-limiting example, the method 300 includes repeating the measurements for each component of each list of components associated with each application server of the list of application servers associated with each system indicated by the data received from the monitoring system.

FIG. 4 is a flowchart of a method 400 for maintaining a system for measuring system performance, in accordance with certain embodiments. The method 400 can be at least partially implemented by a system, such as the CPM system 104 shown in FIG. 1 and/or the computer system shown in FIG. 6, for example. The method 400 is for performing a maintenance action to a repository (e.g., the repository 110) that stores information enabling measuring of system performances. The method 400 includes receiving a menu selection (402), determining a maintenance action indicated by the menu selection (403), and performing a specified maintenance action in response to the determination (411).

The method 400 may start in response to receiving an input from a user, the present system, another system, or a combination thereof, that indicates the present system is to perform the method 400. In a non-limiting example, the method 400 includes starting in response to receiving data from a monitoring system (e.g., the monitoring system 102). The method 400 includes determining an indicator included in the data that indicates a maintenance action to be performed. In a non-limiting example, the maintenance action may include adding a system or a component (e.g., add 404), deleting a system or a component (e.g., delete 406), displaying a list of systems or a list of components of a system (e.g., display 408), and changing a password (e.g., change password 410).

In a non-limiting example, in response to a determination that the maintenance action indicates adding or deleting, the method 400 includes prompting a user for additional information (e.g., prompting for information 412) and then either saving the information 414 or deleting the information 418, respectively. For example, in response to the determination that the maintenance action indicates adding a system, the method 400 includes prompting the user for system details. The system details may include an identifier, a list of one or more components associated with the system, or a combination thereof. The method 400 also includes storing the system details to the repository. In another example, in response to the determination that the maintenance action indicates deleting a system, the method 400 includes prompting the user for a system identifier. The method 400 also includes deleting the system details from the repository based on the system identifier. Prior to deleting, the method 400 may also include prompting the user to verify the system identifier, enter a password to complete the deletion, or a combination thereof. In some examples, deleting the system details includes deleting one or more measurements associated with the system from the repository.

In another example, in response to the determination that the maintenance action indicates adding a component, the method 400 includes prompting the user for component details. The component details may include an identifier, a list of one or more components associated with the component, or a combination thereof. The method 400 also includes storing the component details to the repository. In another example, in response to the determination that the maintenance action indicates deleting a component, the method 400 includes prompting the user for a component identifier. The method 400 also includes deleting the component details from the repository based on the component identifier. Prior to deleting, the method 400 may also include prompting the user to verify the component identifier, enter a password to complete the deletion, or a combination thereof. In some examples, deleting the component includes deleting one or more measurements associated with the component from the repository.

In another example, in response to the determination that the maintenance action indicates to list systems stored to the repository, the method 400 includes generating a report including each system of the list of systems. In another example, in response to the determination that the maintenance action indicates to list components stored to the repository, the method 400 includes generating a report including each component of the list of components. In yet another example, in response to the determination that the maintenance action indicates to list relationships stored to the repository, the method 400 includes generating a report including each system of the list of systems, each component of the list of components, and the relationships between each system and each component.

In response to the determination that the maintenance action indicates to change the password, the method 400 includes prompting the user for a new password (e.g., input password 422). The method 400 also includes encrypting the new password (e.g., input password 424). Additionally, the method 400 includes storing the encrypted new password to the repository (e.g., save password 426).

The steps of the method 200, 300, 400 may be executed by one or multiple computer applications. The steps of the method 200, 300, 400 may be executed in any order, and in any combination, except where logic dictates otherwise, and may individually be executed one or more times. As a non-limiting example, 202 may be executed six (6) times followed by one (1) execution of 204, followed by executions of 206 twelve (12) times then executions of 208 six (6) times, and 210 one (1) time. Executing a step multiple times may ensure an accuracy of data, a repeatability of a determination, or a combination thereof, thereby increasing an accuracy and reliability of outputs of the method 200, 300, 400.

FIG. 5 is an example output 500 of a system or method for measuring system performances, in accordance with certain embodiments. The example output 500 is an output of the CPM system 104 of FIG. 1, the method 200 of FIG. 2, or the method 300 of FIG. 3, for example. The example output 500 includes a graphical plot of performances of multiple components of a system. The system is the monitored system 106 of FIG. 1, for example. The multiple components are multiple computer applications, for example. The example output 500 includes a plot 502 and a plot 504. The plot 502 illustrates a performance of a first component of the system, and the plot 504 illustrates a performance of a second component of the system.

In a non-limiting example, the example output 500 illustrates a performance of the system over a time period indicated as starting at Time Slot 1 and continuing through Time Slot 9. The example output 500 shows that during the Time Slot 2 to the Time Slot 4, the performance of the system is driven by a first component and that during the Time Slot 6 to the Time Slot 8, the performance of the system is driven by a second component. The example output 500 may be used as a baseline to measure future performances of the system against, for example. Deviations from the example output 500 may indicate that the component is responsible for problems with the system.

System 100 of FIG. 1, method 200 of FIG. 2, method 300 of FIG. 3, and method 400 of FIG. 4 may each be partially or wholly implemented, in any combination, as part of a CPM system or multiple CPM systems used by one or more organizations for measuring system performances of the organization generally. While the examples described herein refer to a single organization, one skilled in the art will recognize that the CPM system described herein may provide services to multiple organizations. In a non-limiting example, multiple user systems from multiple organizations may transmit requests to measure system performances via multiple monitoring systems. The SPM system may include multiple repositories (e.g., one or more repositories for each organization of the multiple organizations). Processing a request for measuring system performances may include identifying an organization associated with the request. The CPM system may use the organization identifier to determine a relevant repository to use in processing the request, for example.

The systems (e.g., the system 100 of FIG. 1) and methods (e.g., the method 200 of FIG. 2, the method 300 of FIG. 3, the method 400 of FIG. 4) described herein may be used to identify and quantify system performance, and more specifically, performances of applications and components of the system. Identifying and quantifying performances of applications and components of the system enables determination of root cause analysis of problems with one or more monitored systems by providing information for establishing baseline performance indicators of each component, of each monitored system, and of each set of relationships between multiple components. The monitoring may provide indications that a specific component or specific subset of components of the monitored system are responsible for a decrease in the monitored system responsiveness and may enable identification of anomalies that may lead to cascading performance issues. Identifying root causes, to include prior to a cascading failure, may prevent or reduce monitored system downtime, thereby increasing monitored system stability and user productivity and improving user satisfaction.

In view of the foregoing structural and functional description, those skilled in the art will appreciate that portions of the embodiments described herein may be implemented as a method, data processing system, or computer program product (e.g., computer application). Accordingly, these portions of the present disclosure may take the form of an entirely hardware embodiment, an entirely software embodiment, or an embodiment combining software and hardware, such as shown and described with respect to the computer system of FIG. 6. Furthermore, portions of the embodiments herein may be a computer program product on a computer-readable medium having computer-readable program code on the medium. Any suitable non-transitory computer-readable medium may be utilized including, but not limited to, static and dynamic storage devices, hard disks, optical storage devices, and magnetic storage devices, but excludes any medium that is not eligible for patent protection under 35 U.S.C. § 101 (such as a propagating electrical or electromagnetic signals per se). As an example and not by way of limitation, computer-readable storage media may include a semiconductor-based circuit or device or other integrated circuit (IC) (such, as for example, a field-programmable gate array (FPGA) or an ASIC), a hard disk, an HDD, a hybrid hard drive (HHD), an optical disc, an optical disc drive (ODD), a magneto-optical disc, a magneto-optical drive, a floppy disk, a floppy disk drive (FDD), magnetic tape, a holographic storage medium, a solid-state drive (SSD), a RAM drive, a SECURE DIGITAL card, a SECURE DIGITAL drive, or another suitable computer-readable storage medium or a combination of two or more of these, where appropriate. A computer-readable non-transitory storage medium may be volatile, non-volatile, or a combination of volatile and non-volatile, as appropriate.

Certain embodiments described herein have also been described herein with reference to block illustrations of methods, systems, and computer program products. It will be understood that blocks of the illustrations, and combinations of blocks in the illustrations, can be implemented by machine-readable instructions. These machine-readable instructions may be provided to one or more processors of a general purpose computer, special purpose computer, or other programmable data processing apparatus (or a combination of devices and circuits) to produce a machine, such that the instructions, which execute via the processor, implement the functions specified in the block or blocks. These machine-readable instructions may also be stored in a computer-readable medium that can direct a computer or other programmable data processing apparatus to function in a particular manner, such that the instructions stored in the computer-readable medium result in an article of manufacture including instructions which implement the function specified in the flowchart block or blocks. The machine-readable instructions may also be loaded onto a computer or other programmable data processing apparatus to cause a series of operational steps to be performed on the computer or other programmable apparatus to produce a computer-implemented process such that the instructions, which execute on the computer or other programmable apparatus, provide steps for implementing the functions specified in the flowchart block or blocks.

FIG. 6 is a block diagram of a computer system 600 that can be employed to execute a system for monitoring or measuring system performances in accordance with certain embodiments described. The computer system 600 may be the monitoring system 102, the CPM system 104, the monitored system 106, or the computer system used to implement, in whole or in part, the method 200 of FIG. 2, the method 300 of FIG. 3, or the method 400 of FIG. 4, for example. Computer system 600 can be implemented on one or more general purpose networked computer systems, embedded computer systems, routers, switches, server devices, client devices, various intermediate devices/nodes or standalone computer systems. Additionally, computer system 600 can be implemented on various mobile clients such as, for example, a personal digital assistant (PDA), laptop computer, pager, and the like, provided it includes sufficient processing capabilities.

Computer system 600 includes processing unit 602, system memory 604, and system bus 606 that couples various system components, including the system memory 604, to processing unit 602. Dual microprocessors and other multi-processor architectures also can be used as processing unit 602. System bus 606 may be any of several types of bus structure including a memory bus or memory controller, a peripheral bus, and a local bus using any of a variety of bus architectures. System memory 604 includes read-only memory (ROM) 610 and random access memory (RAM) 612. A basic input/output system (BIOS) 614 can reside in ROM 610 containing the basic routines that help to transfer information among elements within computer system 600.

Computer system 600 can include a hard disk drive 616, a magnetic disk drive 618, e.g., to read from or write to a removable disk 620, and an optical disk drive 622, e.g., for reading a CD-ROM disk 624 or to read from or write to other optical media. Hard disk drive 616, magnetic disk drive 618, and optical disk drive 622 are connected to system bus 606 by a hard disk drive interface 626, a magnetic disk drive interface 628, and an optical drive interface 630, respectively. The drives and associated computer-readable media provide nonvolatile storage of data, data structures, and machine-readable instructions for computer system 600. Although the description of computer-readable media above refers to a hard disk, a removable magnetic disk and a CD, other types of media that are readable by a computer, such as magnetic cassettes, flash memory cards, digital video disks and the like, in a variety of forms, may also be used in the operating environment; further, any such media may contain machine-readable instructions for implementing one or more parts of embodiments shown and described herein.

A number of program modules may be stored in drives and RAM 612, including operating system 632, one or more computer application programs 634, other program modules 636, and program data 638. In some examples, the computer application programs 634 can include one or more sets of machine-readable instructions associated with one or more functions and methods programmed to perform the method 200 of FIG. 2, the method 300 of FIG. 3, or the method 400 of FIG. 4 to measure system performances and the program data 638 can include the example output 500 of FIG. 5. For example, the computer application programs 634 can include the maintenance module 108, the API module 112, the performance measurement module 114, the remote call library 116, or the CPF module 126, and the program data 638 can include the data stored to the repository 110 or the example output 500.

A user may enter commands and information into computer system 600 through one or more input devices 640, such as a pointing device (e.g., a mouse or touch screen), keyboard, microphone, joystick, game pad, scanner, and the like. The user can employ input device 640 to make a selection used by the system 100 of FIG. 1, the method 200 of FIG. 2, the method 300 of FIG. 3, the method 400 of FIG. 4, or the example output 500 of FIG. 5, for example. For example, the user can employ input device 640 to insert comments for different regions of the example output 500. These and other input devices 640 are often connected to processing unit 602 through a corresponding port interface 642 that is coupled to the system bus, but may be connected by other interfaces, such as a parallel port, serial port, or universal serial bus (USB). One or more output devices 644 (e.g., a display, a monitor, a printer, a projector, or other type of displaying device) is also connected to system bus 606 via interface 646, such as a video adapter.

Computer system 600 may operate in a networked environment using logical connections to one or more remote computers, such as remote computer 648. Remote computer 648 may be a workstation, computer system, router, peer device, or other common network node, and typically includes many or all the elements described relative to computer system 600. The logical connections, schematically indicated at 650, can include a local area network (LAN) and a wide area network (WAN). When used in a LAN networking environment, computer system 600 can be connected to the local network through a network interface or adapter 652. When used in a WAN networking environment, computer system 600 can include a modem, or can be connected to a communications server on the LAN. The modem, which may be internal or external, can be connected to system bus 606 via an appropriate port interface. In a networked environment, computer application programs 634 or program data 638 depicted relative to computer system 600, or portions thereof, may be stored in a remote memory storage device 654.

Embodiments disclosed herein include:
A. A system including a remote call library configured to enable communications with a monitored system, a repository configured to store one or more relationships between a plurality of components of the monitored system, and a performance measurement module, implemented by at least one processor, configured to measure a performance of the monitored system using one or more remote calls of the remote call library based on at least one relationship of the one or more relationships between the plurality of components.
B. A method including identifying a number of monitored systems or system components, determining one or more relationships of the monitored systems or system components, determining a performance of the monitored systems or of the system components based on the one or more relationships, and generating a report of the performance.
C. A computer-readable medium storing machine-readable instructions, which, when executed by a processor, cause the processor to identify a monitored system or system components, determine at least one relationship between a plurality of components of the monitored system or system components, measure a performance of the monitored system or system components using one or more remote calls of a remote call library based on the at least one relationship, and transmit the performance via an application programming interface (API).

Each of embodiments A through C may have one or more of the following additional elements in any combination: Element 1: an application programming interface (API) module configured to enable communications with a monitoring system, and where the performance measurement module is configured to determine the at least one relationship based on a communication received via the API module; Element 2: where the performance measurement module is configured to transmit a performance to the monitoring system via the API module; Element 3: an application programming interface (API) module configured to enable communications with a monitoring system, and a maintenance module, implemented by the at least one processor, configured to perform at least one maintenance function based on a communication received via the API module; Element 4: where the monitored system is a first monitored system, and where the at least one maintenance function is configured to include one or more of: adding data to the repository, deleting data from the repository, or determining data stored to the repository; Element 5: where the performance measurement module is configured to transmit data stored to the repository to the monitoring system via the API module; Element 6: where the plurality of components is a first plurality of components, and where the data includes one or more of a first component of the first plurality of components, the first plurality of components, the first monitored system, a second monitored system having a second plurality of components, a second component of the second plurality of components, or the second plurality of components; Element 7: where the repository is configured to encrypt the one or more relationships between the plurality of components of the monitored system, and where the performance measurement module is configured to decrypt the at least one relationship of the encrypted one or more relationships between the plurality of components; Element 8: where the plurality of components comprise one or more standard components, one or more middleware components, one or more computer application components, or a combination thereof; Element 9: where the one or more relationships describe a first set of dependencies between a middleware component and one or more standard components, a second set of dependencies between a computer application component and one or more middleware components, a third set of dependencies between the computer application component and one or more standard components, or a combination thereof; Element 10: determining one or more measurements of each component of each monitored system of the number of monitored systems or of the system components, and determining the performance of each monitored system of the number of monitored systems or of the system components based on the one or more measurements; Element 11: storing the one or more measurements of each component of each monitored system of the number of monitored systems or of the system components, and storing the performance of each monitored system of the number of monitored systems or of the system components; Element 12: encrypting the one or more measurements of each component of each monitored system of the number of monitored systems or of the system components and the performance of each monitored system of the number of monitored systems or of the system components prior to storing; Element 13: determining one or more baselines based on the stored one or more measurements of each component of each monitored system of the number of monitored systems or of the system components, the stored performance of each monitored system or of the system components, or a combination thereof; Element 14: where the one or more baselines comprises at least one of a first baseline of a first monitored system of the number of monitored systems, a second baseline of a computer application component of the first monitored system, or a third baseline of a middleware component of the first monitored system; Element 15: where the processor is operable to: encrypt the performance of the monitored system or system components, store the encrypted performance to a repository, retrieve the plurality of components stored to the repository, and delete data of the monitored system or system components stored to the repository, where the data comprises one or more encrypted performances and the plurality of components; Element 16: where the processor is operable to: determine one or more measurements of each component described by the at least one relationship to measure the performance of the monitored system or system components, encrypt the one or more measurements, and store the encrypted one or more measurements to the repository; Element 17: where the processor is operable to: determine at least one baseline based on the one or more measurements, encrypt the at least one baseline, and store the encrypted at least one baseline to the repository.

By way of non-limiting example, exemplary combinations applicable to A through C include: Element 1 with Element 2; Element 3 with Element 4; Element 3 with Element 5; Element 3 with Element 6; Element 4 with Element 5; Element 4 with Element 6; Element 5 with Element 6; Element 9 with Element 10; Element 9 with Element 11; Element 9 with Element 12; Element 9 with Element 13; Element 9 with Element 14; Element 10 with Element 11; Element 10 with Element 12; Element 10 with Element 13; Element 10 with Element 14; Element 11 with Element 12; Element 11 with Element 13; Element 11 with Element 14; Element 13 with Element 14; Element 15 with Element 16; Element 15 with Element 17; and Element 16 with Element 17.

The terminology used herein is for the purpose of describing particular embodiments only and is not intended to limit this disclosure. As used herein, the singular forms “a,” “an,” and “the” are intended to include the plural forms as well, unless the context clearly indicates otherwise. It will be further understood that the terms “contains,” “containing,” “includes,” “including,” “comprises,” and/or “comprising,” and variations thereof, when used in this specification, specify the presence of stated features, integers, steps, operations, elements, and/or components, but do not preclude the presence or addition of one or more other features, integers, steps, operations, elements, components, and/or groups thereof. Also, the phraseology and terminology used herein is for the purpose of description and should not be regarded as limiting. The use of “including,” “comprising,” “having,” “containing,” “involving,” and variations thereof herein is meant to encompass items listed thereafter and equivalents thereof, as well as additional items. While the disclosure has described several exemplary embodiments, it will be understood by those skilled in the art that various changes can be made, and equivalents can be substituted for elements thereof, without departing from the spirit and scope of the invention.

In addition, many modifications will be appreciated by those skilled in the art to adapt a particular instrument, situation, or material to embodiments of the disclosure without departing from the essential scope thereof. Therefore, it is intended that the invention not be limited to the particular embodiments disclosed, or to the best mode contemplated for carrying out this invention, but that the invention will include all embodiments falling within the scope of the appended claims. While the present disclosure has been described with respect to a limited number of embodiments, those skilled in the art, having benefit of this disclosure, will appreciate that other embodiments may be devised which do not depart from the scope of the disclosure as described herein. Accordingly, the scope of the disclosure should be limited only by the attached claims.

The invention claimed is:

1. A system comprising:
a remote call library configured to enable communications with a monitored system;
a repository configured to store one or more relationships between a plurality of components of the monitored system; and
a performance measurement module, implemented by at least one processor, configured to measure a performance of the monitored system using one or more remote calls of the remote call library based on at least one relationship of the one or more relationships between the plurality of components.

2. The system of claim 1, comprising:
an application programming interface (API) module configured to enable communications with a monitoring system; and
wherein the performance measurement module is configured to determine the at least one relationship based on a communication received via the API module.

3. The system of claim 2, wherein the performance measurement module is configured to transmit a performance to the monitoring system via the API module.

4. The system of claim 1, comprising:
an application programming interface (API) module configured to enable communications with a monitoring system, and
a maintenance module, implemented by the at least one processor, configured to perform at least one maintenance function based on a communication received via the API module.

5. The system of claim 4, wherein the monitored system is a first monitored system, and wherein the at least one maintenance function is configured to include one or more of: adding data to the repository, deleting data from the repository, or determining data stored to the repository.

6. The system of claim 5, wherein the performance measurement module is configured to transmit data stored to the repository to the monitoring system via the API module.

7. The system of claim 6, wherein the plurality of components is a first plurality of components, and wherein the data includes one or more of a first component of the first plurality of components, the first plurality of components, the first monitored system, a second monitored system having a second plurality of components, a second component of the second plurality of components, or the second plurality of components.

8. The system of claim 1, wherein the repository is configured to encrypt the one or more relationships between the plurality of components of the monitored system; and
wherein the performance measurement module is configured to decrypt the at least one relationship of the encrypted one or more relationships between the plurality of components.

9. The system of claim 1, wherein the plurality of components comprise one or more standard components, one or more middleware components, one or more computer application components, or a combination thereof.

10. A method comprising:
identifying a number of monitored systems or system components;
determining one or more relationships of the monitored systems or system components;
determining a performance of the monitored systems or of the system components based on the one or more relationships; and
generating a report of the performance.

11. The method of claim 10, wherein the one or more relationships describe a first set of dependencies between a middleware component and one or more standard components, a second set of dependencies between a computer application component and one or more middleware components, a third set of dependencies between the computer application component and one or more standard components, or a combination thereof.

12. The method of claim 11, further comprising:
determining one or more measurements of each component of each monitored system of the number of monitored systems or of the system components; and
determining the performance of each monitored system of the number of monitored systems or of the system components based on the one or more measurements.

13. The method of claim 12, further comprising:
storing the one or more measurements of each component of each monitored system of the number of monitored systems or of the system components; and
storing the performance of each monitored system of the number of monitored systems or of the system components.

14. The method of claim 13, further comprising encrypting the one or more measurements of each component of each monitored system of the number of monitored systems or of the system components and the performance of each monitored system of the number of monitored systems or of the system components prior to storing.

15. The method of claim 13, further comprising determining one or more baselines based on the stored one or more measurements of each component of each monitored system of the number of monitored systems or of the system components, the stored performance of each monitored system or of the system components, or a combination thereof.

16. The method of claim 15, wherein the one or more baselines comprises at least one of a first baseline of a first monitored system of the number of monitored systems, a second baseline of a computer application component of the first monitored system, or a third baseline of a middleware component of the first monitored system.

17. A non-transitory, computer-readable medium storing machine-readable instructions, which, when executed by a processor, cause the processor to:
identify a monitored system or system components;
determine at least one relationship between a plurality of components of the monitored system or system components;
measure a performance of the monitored system or system components using one or more remote calls of a remote call library based on the at least one relationship; and
transmit the performance via an application programming interface (API).

18. The non-transitory, computer-readable medium of claim 17, wherein the processor is operable to:
encrypt the performance of the monitored system or system components;
store the encrypted performance to a repository;
retrieve the plurality of components stored to the repository; and
delete data of the monitored system or system components stored to the repository, wherein the data comprises one or more encrypted performances and the plurality of components.

19. The non-transitory, computer-readable medium of claim 18, wherein the processor is operable to:
determine one or more measurements of each component described by the at least one relationship to measure the performance of the monitored system or system components;
encrypt the one or more measurements; and
store the encrypted one or more measurements to the repository.

20. The non-transitory, computer-readable medium of claim 19, wherein the processor is operable to:
determine at least one baseline based on the one or more measurements;
encrypt the at least one baseline; and
store the encrypted at least one baseline to the repository.
